(19) United States
(12) Patent Application Publication
(10) Pub. No.: US 2003/0074225 A1
(43) Pub. Date: Apr. 17, 2003

(54) Pharmaceutical information tracking system

(76) Inventors: Gerald C. Borsand, Bloomfield Hills, MI (US); Sue Ann Syoen, Beverly Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/976,650

(22) Filed: Oct. 12, 2001

(51) Int. Cl. G06F 17/60

(52) U.S. Cl. 705/3

(57) ABSTRACT

A system that facilitates direct, efficient, non-linear, integrated and proactive communications between a payor, a PBM, a pharmacy, and health care provider such as a physician. The system increases efficiency and reducing costs by reducing the number of processes needed to prescribe pharmaceuticals in accordance with the policies of a payor or PBM. The system can pre-certify prescriptions, check of for unfavorable pharmaceutical interactions and allergic reactions, prevent misuse of a prescription, monitor the filling and re-filling of a prescription, as well as cancel a prescription after it has been issued by a provider. Instead of merely allowing different entities to communicate with each other through interfaces and other indirect means, one embodiment of the system actually centralizes the information storage into a one or more locations that are accessible to all the appropriate entities.

### BACKGROUND OF THE INVENTION

The present invention relates in general to systems for transmitting pharmacy information. In particular, the invention relates to a computer-based system to facilitate timely, flexible, proactive, comprehensive and direct electronic communications between a payor, pharmacy benefit managers (“PBMs”), pharmacies, and health care providers such as physicians.

The complexity of the health care industry is due at least in part to the number of entities involved in each transaction. Unlike other industries, most health care transactions involve more than just a buyer and a seller. Pharmaceutical transactions are no exception to such complexity. It is not uncommon for a single pharmaceutical transaction to involve a patient, a health care provider, a pharmacy, a PBM, and a payor such as an insurance company, an employer, or a government funded health care program. Despite the fact that multiple entities are often involved in the pharmaceutical prescription process, the existing art does not provide an efficient way for such entities to interact with each other. The existing art provides mechanisms for linear, reactive, indirect, and inefficient communication. It would be desirable for the various entities involved in a pharmaceutical transaction to communicate directly with each other in a proactive, direct and efficient manner.

As a result of the numerous entities involved in a pharmaceutical transaction, prior art systems and methods do not manage and utilize information in an efficient manner. Linear and reactive communications result in a lack of centralized data access, duplicative efforts, and redundant information while at the same time such systems fail to provide access to important information to the appropriate entities. It would be desirable for pharmaceutical information to be stored only once and in a centralized location accessible by the appropriate parties. It would also be advantageous if the various parties entitled to such information could access the information in a direct and timely manner.

Under prior art systems, physicians provide handwritten prescriptions to patients who then present the paper prescriptions to pharmacists who then contact a PBM or payor to submit the claim after the pharmaceutical decision of the physician has long since been made. The feedback of a PBM or a payor is not received by the physician or the pharmacy until after a prescription is issued by the physician. Sometimes such feedback is not received until after a prescription is inadvertently filled and distributed to a patient. It would be beneficial if a payor or PBM could assert the appropriate guidelines, rules, and policies before a physician selects a pharmaceutical product for a particular patient. It would also be beneficial if the appropriate guidelines, rules, and policies were accessible to providers and pharmacists in a real-time manner throughout the life cycle of a prescription. Real-time access to relevant information would allow the rules, policies, and guidelines of payors and PBMs to manifest themselves proactively throughout the process instead of merely at the claims submission stage. Without such a proactive influence, the total number of communications, transactions, and other activities between the various involved entities increases as a result of unnecessary “follow-ups” and “re-works.” Just as automotive manufacturers transformed their vision of quality from something confirmed at the end of the manufacturing process into a paradigm of building quality continuously into the process or product, it would be desirable for mistakes and redundancies to be avoided before subsequent activities magnify any resulting errors and inefficiencies.

The failure of existing systems to manage information in an efficient manner results in unnecessary health risks. A prescribing physician may not realize the extent or nature of a patient's pharmaceutical history before a drug is prescribed. It would be helpful if timely feedback were provided relating to potential pharmaceutical conflicts or with respect to allergic reactions to pharmaceutical products. It would also be helpful if a provider could view treatment protocols, up-to-date formulary lists, benefit designs, and convey accurate pharmaceutical prescriptions to pharmacies without the necessity of a pharmacist struggling to read the handwritten prescription. It would also be advantageous if a physician could monitor a patient's pharmaceutical compliance and utilization, canceling such prescriptions when helpful to avoid the misuse of such prescriptions. For example, it would be desirable if a pharmacist could be prevented from filling a prescription at half strength but twice the volume and cost. It would also be desirable if a pharmacists could be prevented from filling redundant prescriptions from two or more providers.

Existing methodologies and systems involve unnecessary costs. Pharmacies often need to re-submit claims to a payor or PBM. It would be beneficial if such prescriptions could be pre-certified at a time before a prescription is generated by a provider, much less filled by a pharmacist. A robust pre-certification process benefits all parties to a pharmaceutical transaction by reducing costs and eliminating the need to alter a prescription after it has already been issued by a provider. It would also be desirable for prescriptions to be issued in a predefined format to enhance comprehension by the pharmacy.

The entire health care industry is very much concerned with reducing systemic fraud, redundancy, abuse, misuse, and errors (collectively “F.R.A.M.E.”). Many of these obstacles are the result of fragmented processes and insufficient information flow; factors that would be substantially reduced by an integrative system connecting the appropriate persons and organizations.

A more timely and continuous exchange of comprehensive pharmaceutical-related data may eventually facilitate new types of transactions between physicians, pharmacies, PBMs, and payors. All of these entities may find new ways to convey value to another through an appropriate modification in behavior, and through such changes, the health care system as a whole, including ultimately patients, will derive additional efficiencies from entirely new types of transactions and financial relationships.

Although regulatory and legislative efforts such as the Health Insurance Portability and Accountability Act of 1996 (“HIPAA”) were enacted in part to facilitate better communications between health care entities by standardizing electronic formats for data transmissions, even post-HIPAA systems and methods fail to truly integrate the data requirements of multiple entities. It may be desirable for providers, pharmacies, PBMs, and payors to utilize the same information management system, instead of merely building interfaces and data pipes to facilitate the exchange of data between different systems.

### SUMMARY OF THE INVENTION

The present invention relates to a computer based system for tracking information related to pharmaceutical prescriptions, and communicating the information to all entities appropriately involved in that particular prescription. The invention supports direct, proactive, and timely communication between a payor, pharmacy benefit managers (“PBMs”), pharmacies, and providers. Such communication facilitates cost savings and eliminates unnecessary processes and “re-work.” It is more efficient to take the correct action once then it is to take an incorrect action, and then spend time and energy trying to correct past mistakes.

The invention allows a health care provider such as a physician or physician's assistant to pre-certify prescriptions before a particular prescription is issued. Undesirable pharmaceutical interactions and allergic reactions can also be detected before a prescription is issued. Drug utilization, treatment protocols, formulary, and payor guidelines can be consulted before a pharmacy fills a prescription and even before a health care provider issues a prescription to a patient. Refill activities can be monitored by the system, and if necessary, a prescription can be canceled by a health care provider even after it has been issued to a patient. In one embodiment of the invention, the payor, PBM, pharmacy, and provider all access the information stored as the same centralized location.

Various advantages and aspects of this invention will become apparent to those skilled in the art from the following detailed description of the preferred embodiment, when read in light of the accompanying drawings.

### BRIEF DESCRIPTION OF THE DRAWINGS

FIG. 1 is a high-level diagram illustrating direct communication between a provider, a pharmacy, a PBM, and a payor, as well as some of the elements processed by the system.

FIG. 2 is a prior art diagram illustrating how a provider, a pharmacy, a PBM, and a payor interact in the prior art, and the inability of a parties to interact directly with each other.

FIG. 3 is a diagram illustrating one potential technical architecture of the system.

FIG. 4a is a site map drawing of the provider home page, and various aspects of the prescription subsystem.

FIG. 4b is an input-output flowchart for the process of generating a prescription using the prescription subsystem.

FIG. 4c is an input-output flowchart incorporating a pre-authorization verification into the process of generating a prescription using the prescription subsystem.

FIG. 4d is an input-output flowchart for processing detailed prescription information using the prescription subsystem.

FIG. 5 is a site map drawing of a payor home page, and various aspects of the reimbursement subsystem.

FIG. 6 is a site map drawing of a PBM home page, and various aspects of the reimbursement subsystem.

FIG. 7 is a site map drawing for filling prescriptions, and other functions of the pharmacy subsystem.

FIG. 8 is a site map drawing for a patient page, and some of the various pages and functionality accessible from that page.

FIG. 9 is a prior art flow chart illustrating how payors and PBMs respond to claims submissions in the prior art.

FIG. 10 is a flow chart illustrating the pre-certification of a prescription using the invention.

FIG. 11 is a flow chart illustrating the cancellation of a prescription using the invention.

### DETAILED DESCRIPTION OF THE PREFERRED EMBODIMENT

I. Overall Process Flow and Key Elements

A. Key Entities and Elements

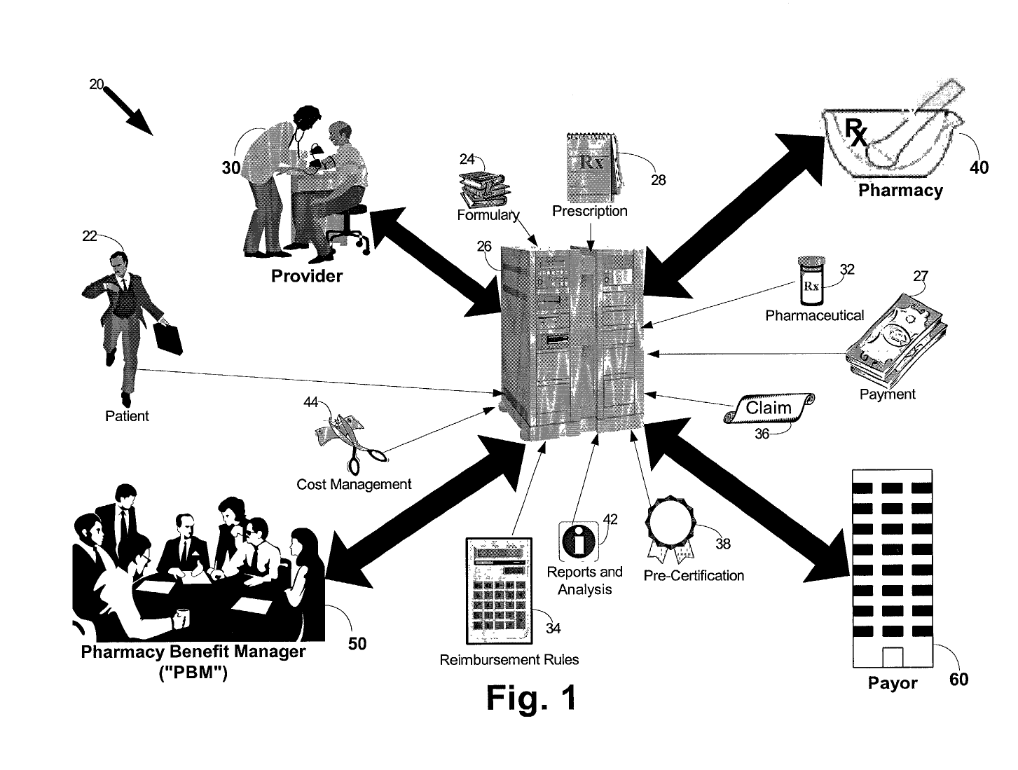

FIG. 1 discloses a diagram of an integrated system 20 which allows health care providers 30, pharmacists 40, pharmacy benefit managers (“PBMs”) 50, and payors 60 to interact with each other in a non-linear, direct, proactive, integrated, and comprehensive manner. The Figure illustrates some of various entities involved in the life cycle of a pharmaceutical prescription (“prescription”) 28 and some of the elements processed by the system 20.

A patient 22 is any organism requiring medical treatment, including non-human organisms such as domesticated pets and other animals. In a preferred embodiment of the invention, the patient 22 is a human being enrolled as a member in a health plan of a payor 60, and the payor 60 uses a PBM 50 to manage pharmacy benefits. A payor 60 can be a health insurance company, a non-profit organization such as Blue Cross and Blue Shield organization, an employer funded health plan, a health maintenance organization (“HMO”), a government health program such as Medicaid or Medicare, or any other entity responsible for reimbursing health care providers 30, pharmacists 40, and patients 22 for the medical treatments provided to patients 22. A single payor 60 can have many different types and instances of health plans. A single payor 60 can also utilize many different PBMs 50. A PBM 50 is any entity empowered by a payor 60 to manage pharmaceutical benefits for members of the payor 60. In an alternative embodiment, a PBM 50 can be part of or related to the payor 60. A health care provider 30 includes any person capable of issuing a pharmaceutical 32 prescription 28 such as a physician, physician's assistant, or veterinarian. A pharmacist 40 is any person authorized to fill prescriptions 28 by dispensing the appropriate pharmaceutical 32 product for a patient 22.

The patient 22 can visit the provider 30 in a variety of different settings, including but not limited to hospitals, emergency rooms, private practice offices, HMOs, medical clinics, etc. In treating a particular patient 22, the provider 30 may determine that a pharmaceutical 32 might be helpful for a patient 22. There are many different variables or characteristics that can affect the particular desirability of a particular pharmaceutical 32 in a particular treatment situation. A preferred embodiment of the invention includes an electronic formulary 24. The formulary 24 is housed in a computer 26 where it can be accessed by providers 30, pharmacists 40, PBMs 50, and payors 60. The computer 26 can be a single centralized computer or server, a single network, a series of interconnected networks, a series of devices capable of accessing the Internet or World Wide Web including an application server, or any other configuration which supports the ability of different entities to communicate with one another.

A formulary 24 is a listing of potential pharmaceutical 32 products, along with information relating to side effects, interactions with other pharmaceuticals 32, interactions with patient 22 allergies, dosage levels, cost, and other pertinent medical and business information. In a preferred embodiment of the invention, the formulary 24 takes into account a set of reimbursement rules 34 by a PBM 50 or payor 60. Reimbursement rules 34 can include or be based on eligibility, cost criteria, cost analysis, treatment protocols, utilization analysis, formulary limitations, patient attributes including medication history and allergy reactions, or any other medical or business characteristic or attribute. Reimbursement rules 34 could be derived from one of the various reports and/or analysis 42 generated by the system 20 itself. There are at least three categories of reports 42 (compliance, utilization, and statistical) that can be generated by the system 20.

In a preferred embodiment, the provider 30 should consult the formulary 24 before a prescription 28 for a pharmaceutical 32 is generated using the system 20. This facilitates the avoidance of unfavorable medical and business outcomes. One advantage of the system 20 is the ability of a provider 30 to generate a pre-certified 38 prescription 28. If a pharmaceutical 32 selection complies with the reimbursement rules 34 of a payor 60 or PBM 50, the prescription 28 can be subject to automated pre-certification 38 by a provider 30 before it is issued to a patient 22 and before it is filled by a pharmacist 40. The pre-certified 38 prescription 28 can be sent to a pharmacy 40 directly by the system 20, or by the patient 22 presenting a preformatted written prescription 28 to the pharmacy. The pharmacy 40 can confirm the lack of drug interactions, allergic reactions, protocol compliance, and otherwise confirm that the issued prescription 28 is pre-certified 38 and in compliance with the appropriate rules and policies 34.

The system 20 provides functionality for tracking pharmaceutical 28, prescription 32, and related information. The system 20 can temporarily or permanently link together the prescription 32 with the diagnosis resulting in the provider's 30 pharmaceutical 28 decision. Such linkage can allow the system 20 to track diagnosis information at potentially any time that prescription 32 information is also being tracked. Providers 30, pharmacists 40, PBMs 50, and payors 60 can track the diagnosis and the prescription 32, consistent with whatever privacy rules are incorporated into the system 20. The system 20 can also support tracking pharmaceutical 28, prescription 32, and related information throughout the life cycle of the pharmaceutical 28 or prescription 32. The system 20 can track whether or not a prescription 32 has been filled. The system 20 can track whether of not a patient 22 has attempted to refill a prescription 32 before the pharmaceutical 28 in the initial prescription 32 was to have run out in accordance with the prescribed use of the pharmaceutical 28. The system 20 can also track claim 36 and reimbursement 27 information relating to the prescription 28 in a comprehensive and flexible manner. Payors 60, PBMs 50, pharmacists 40, and providers 30 can access such information in accordance with the privacy rules incorporated into the system. Information tracking can be in a proactive and real-time manner, or in the form of reports and analysis 42 taking place after the events have already occurred. If a patient 22, provider 30, pharmacist 40, or PBM 50 attempts an action that not in accordance with the predefined rules 34 of the payor 60, the system 20 can be configured to not allow the attempted conduct, or to allow the conduct, but generate a report 42 relating to the undesirable activity. Such flexibility is supported by predefined rules34 incorporated into the system 20, which can be customized as desired.

At the time that a prescription 28 is filled by the pharmacy 40 for a particular patient 22, the system 20 generates an electronic representation of the pharmaceutical 28. A claim 36 is then generated for either the PBM 50 or the payor 60. The system 20 can also facilitate electronic reimbursement or payment 27 of the claim 36. In an alternative embodiment of the invention, there is no PBM 50, and all work performed by the PBM 50 is instead performed by the payor 60.

The system 20 provides an effective mechanism for cost management 44 by facilitating direct access to a computer 26 by the payor 60, PBM 50, pharmacy 40, or provider 30. The computer 26 can be any computational or communication device or network of devices capable of transmitting and receiving information. By allowing different entities to interact with a prescription 28 over the life cycle of that script 28, the system 20 facilitates the advances described in greater detail below.

The system 20 supports the ability of a payor 60 to enforce reimbursement rules 34 in a proactive manner. The system 20 supports the ability to of the reimbursement rules 34 to manage eligibility, authorizations, and certifications. Eligibility is a term used to describe whether a patient 22 is a member of a health plan of a particular payor 60. For example, if insurance coverage was terminated with regards to a particular patient 22, that patient 22 would not be eligible for medical coverage from that payor 60. Any provider 30 or pharmacist 40 providing services to such a patient 22 would not receive any reimbursements 27 from the payor 60. Authorization is a similar term that relates to the benefits covered by a particular reimbursement rules 34 for a particular health plan of a particular payor 60. Authorization is concerned with whether a drug 32 is on formulary 24, or is otherwise approved for reimbursement 27 by a payor 60. Certification is a term closely related to authorization. Certification indicates that a claim 36 has passed all system 20 edits and has been approved by the system 20 to be dispensed by the pharmacist 40. In various circumstances, authorization provides for the pre-certification 38 of a prescription 28.

The system 20 facilitates the achievement of cost savings or management 44 for potentially all of the entities involved in the life cycle of a prescription 28, including patients 22, payors 60, PBMs 50, providers 30, and pharmacists 40. In the prior art, fraud, redundancy, pharmaceutical abuse, pharmaceutical misuse, and errors (collectively “F.R.A.M.E.”) increase costs for all of the entities involved. By facilitating direct communications, the system 20 reduces F.R.A.M.E.

B. The Prior Art Does not Integrate Communications

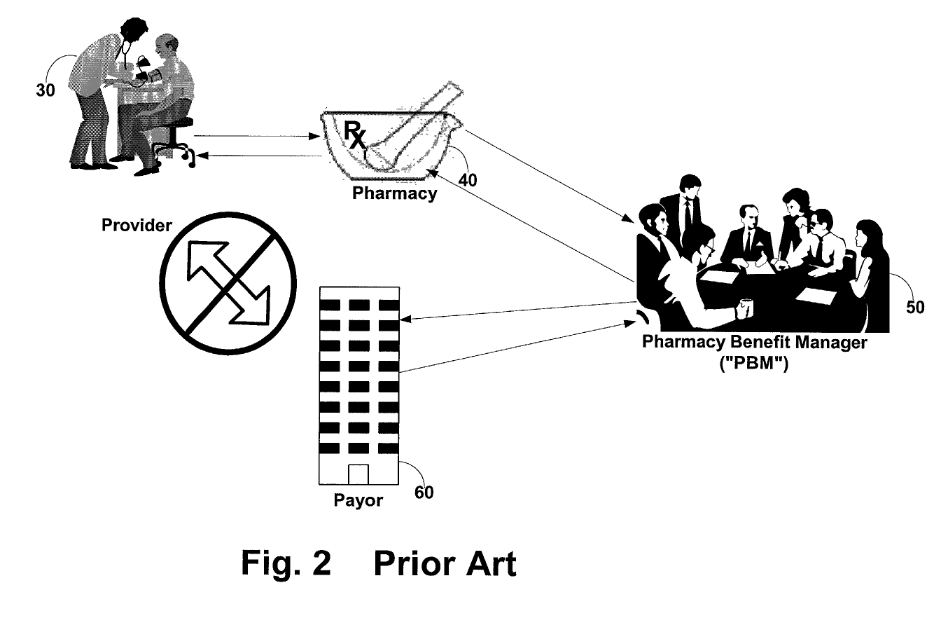

In contrast to FIG. 1, which illustrates a system 20 in which the payor 60, PBM 50, pharmacy 40, and provider access and manipulate the same information on the computer 26, the prior art does not provide such an integrated system. FIG. 2 discloses a high-level view of a typical prior art system. In a typical prior art system, a provider 30 deals solely with the patient 22, and generally has no pharmaceutical-related communication with the pharmacist 40, PBM 50, or payor 60 before issuing a prescription 28. At most, the provider 30 may receive a quick phone call from a pharmacy 40 after the provider 30 has issued a prescription 28 to confirm a prescription 28 or to inform that provider 30 that a payor 60 or PBM 50 has denied reimbursement 27 of a particular claim 36. A pharmacy 40 has no direct contact with a payor 60 in the prior art, and instead relies on communicating with the PBM 50 as a middle-man. In the prior art, the PBM 50 is the only entity that can directly access a payor 60 and its reimbursement rules 34. More specifically, any attempt by a provider 30 to certify a prescription 28 must go through both the pharmacy 40 and the PBM 50 to ultimately reach the payor 60. The payor's 60 feedback is similarly indirect, going first through the PBM 50 and pharmacy 40 before reaching the provider 30.

The linear nature of the communications in the Figure impedes the ability of PBMs 50 and payors 60 to make the reimbursement rules 34 and approved formulary 24 known to pharmacists 40 and providers 30. This lack of direct communication isolates the reimbursement subsystem from the other subsystems in the pharmaceutical information system. Similarly, prior art systems impede providers 30 from communicating with payors 60, PBMs 50, and pharmacists 40 with respect to prescription 28 issues, isolating the prescription subsystem in the current art. Under prior art systems, a pharmaceutical subsystem relating to pharmacists 40 and their prescription filling activities isolated from other aspects of the pharmaceutical information system. The process flow in FIG. 2 is easily contrasted with the process flow in FIG. 1, wherein each entity directly interacts with the computer 26 in which other entities also interact.

C. Technical Architecture

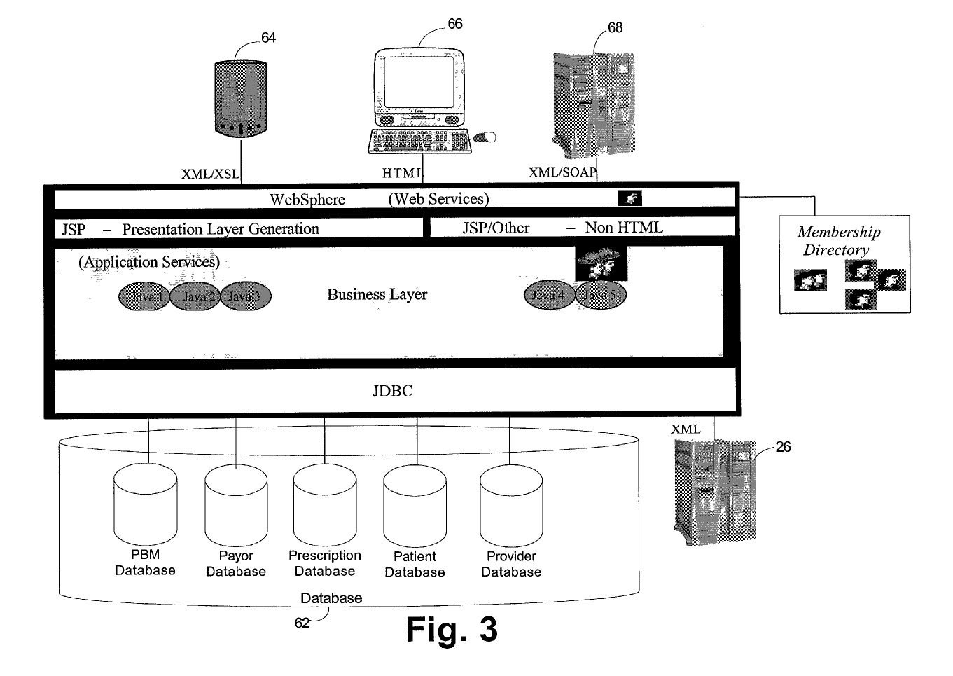

FIG. 3 discloses some of the underlying technical architecture that could be utilized to support the system 20. In a preferred embodiment of the invention, all pharmaceutical-related information is stored on a single database 62 that is accessible to any party subject to the appropriate privacy regulations, policies, and guidelines. In alternative embodiments of the invention, multiple databases are used to store pharmaceutical information. PBMs 50, payors 60, patients 22, providers 30, and prescriptions 28 can each have their own separate databases 62, which can in interconnected or kept separate, but each are accessible from the computer 26 housing the computer programs used by the system 20. The computer programs themselves can also be used and stored in a decentralized manner so long as the various entities can communicate with each other. In a preferred embodiment of the invention, a relational database using SQL (Standard Query Language) is used by the system 20. Alternative embodiments could use any type of database 62 or even flat file storage formats. The extent and nature of data sharing and data access needs to be negotiated between a payor 60 and the corresponding PBM 50, pharmacy 40, or provider 30. Privacy regulations such as those pursuant to HIPAA (the “Health Insurance Portability and Accountability Act of 1996”) should also be taken into account.

In a preferred embodiment of the invention, the computer system 26 houses computer software written in the programming language of Java. In alternative embodiments, the software could be written in any other language capable of allowing payors 60, PBMs 50, pharmacists 40, and providers 30 to interact with each other. The Java Database Client (“JDBC”) layer connects the database(s) 62 to the computer 26 housing the computer programs used by the system 20. In a preferred embodiment of the invention, the computer 26 uses XML files (extensible Markup Language) to interface with the JDBC layer.

Above the JDBC layer is the business layer, which contains the programming logic of the system 20. Each instance of an active software application has its own java bean session in the business layer. Above the business layer are the presentation layers, which can make the system 20 available through use of a web browser or other interface. XML, XSL (eXtensible Stylesheet Language), HTML (Hypertext Markup Language), SGML (Standard Generalized Markup Language), SOAP (Simple Object Access Protocol) or any other data format can be used to allow various users such as providers 30, pharmacists 40, PBMs 50, or payors 60 to access the system 20. To facilitate convenient access for providers 30 as they see patients 22, a hand held wireless device 64 such as a personal digital assistant (“PDA”), pager, cellular phone, or other device could be used to access the system 20. Any other method for accessing the Internet such as a stand alone computer 66, a terminal, or a networked computer or work station can also be used to access the system 20. To facilitate the potentially substantial data integration requirements of a payor 60, PBM 50, or other user, the interface to the system 20 can be another computer 68, which could be a mainframe, workstation, intranet, extranet, LAN (local area network), WAN (wide area network), stand alone PC, or some other data processing configuration.

The system 20 is highly flexible, and can utilize any device capable of communicating with other devices. Hard copies of documents can be scanned into an electronic format by a scanner and inputted electronically into the system 20. Voice recognition technology could facilitate the use of a telephone or cell phone to access the system 20. A fax machine could be used to send and receive information from the computer 26.

Alternative embodiments can incorporate a wide variety of different architectures. The system 20 is not limited to Internet or web based embodiments, or even to computer systems utilizing a graphical user interface. The system 20 can utilize any architecture capable of allowing providers 30, pharmacists 40, PBMs 50, and payors 60 to communicate with each other.

II. Different Entities Utilize Different Subsystems

A. Prescription Subsystem

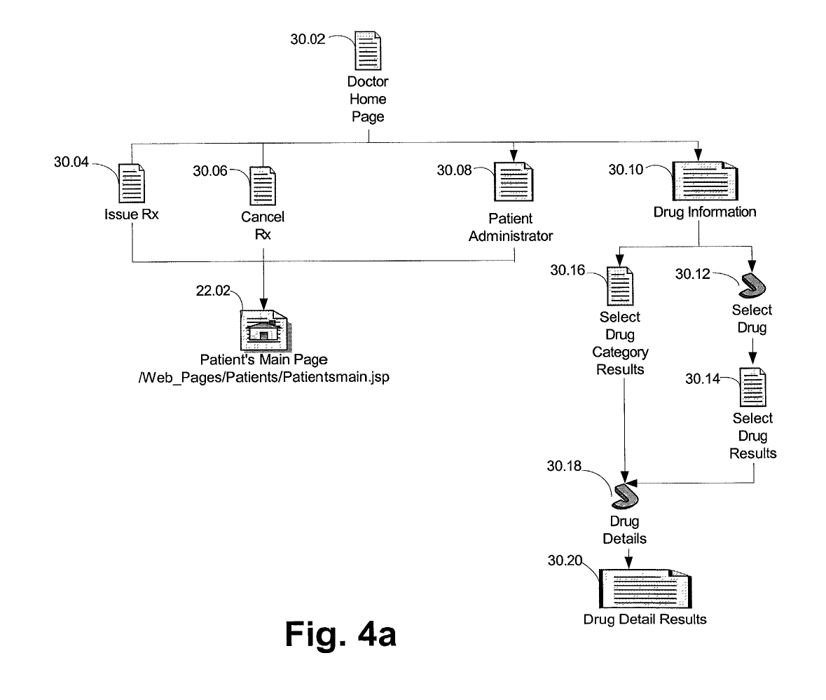

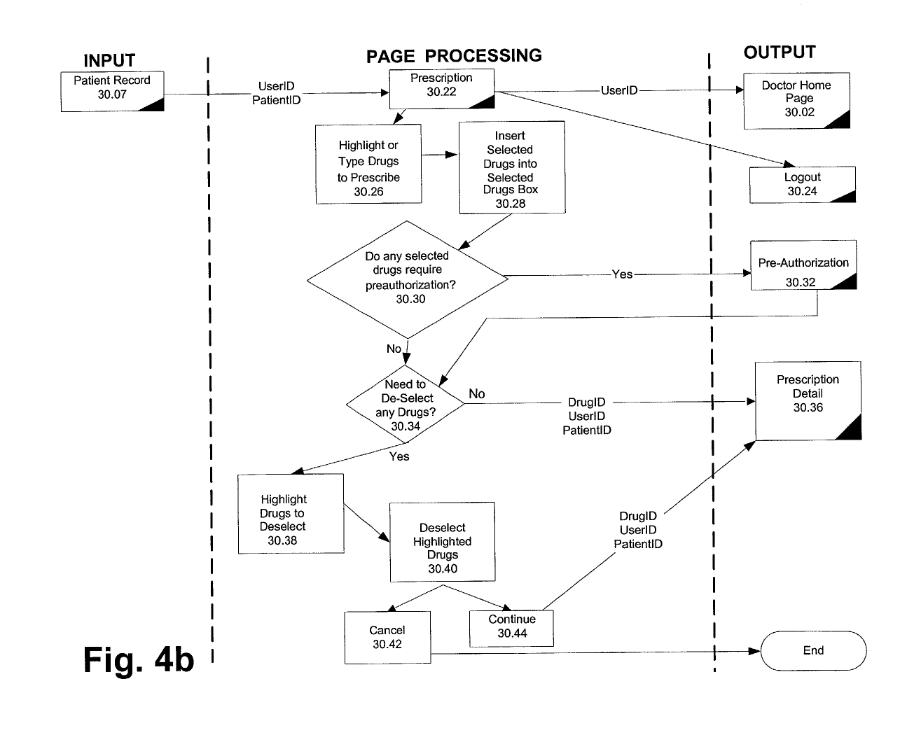

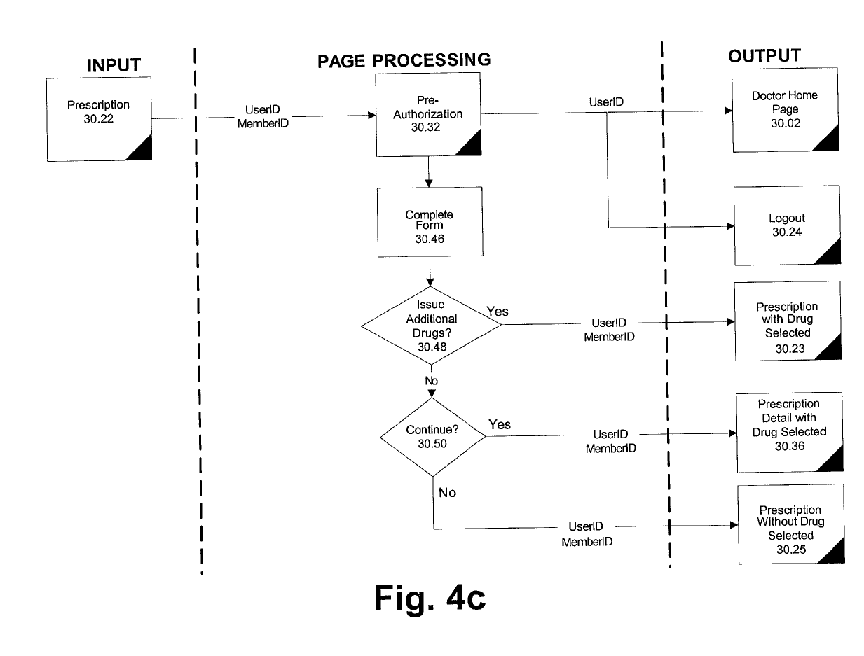

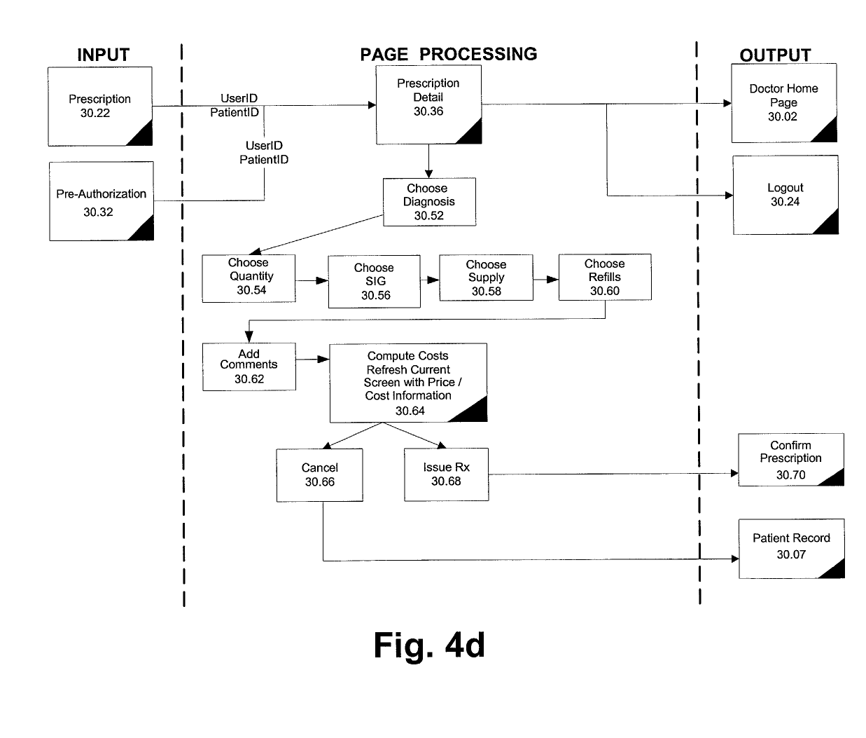

The prescription subsystem is used by a provider 30 to generate prescriptions 32 for a patient 22. FIG. 4a discloses a site map diagram of a provider home page 30.02 and other pages accessible through that page. Prescriptions 28 can only be issued by a certain subset of health care providers 30 such as physicians, physician assistants, or nurse practitioners. For the purposes of the system 20, only those personnel authorized to issue prescriptions 28 are providers 30. Other health care personnel such as nursing assistants can view data through a provider home page 30.02, but are not able to alter data or to issue prescriptions 28. The subsystem accessed by providers 30 is a prescription subsystem that is accessible from a home page as identified at 30.02.

The system 20 is designed to maximize flexibility for the provider 30, and the provider 30 is not forced to follow any particular order of processing unless business logic requires such a constraint. In a preferred embodiment of the invention, the software in the computer 26 is written in an object-oriented language such as Java, and can perform event-based processing. There are essentially four actions that a provider 30 can initiate from the home page at 30.02.

A prescription 28 can be issued at 30.04 or cancelled at 30.06. Patient administration functions can be initiated and performed at 30.08. If the provider 30 wishes to view formulary 24 and other pharmaceutical information before issuing a prescription 28, drug information can be viewed at 30.10.

The process of creating a prescription 28, canceling a prescription 28, or accessing patient-related information is done in the context of a particular patient 22. Patient 22 attributes include the patient's medical condition to be remedied or mitigated with a pharmaceutical 32; medical history such as allergies and medication history; eligibility and other coverage information relating to payor's 60 health plan; refill behavior; and any other characteristic or attribute that could affect the desirability of a pharmaceutical 32 or prescription 28 with respect to a particular patient 22. Reimbursement rules 34 provider can provide a guideline for a particular patient based on a single patient 22 characteristic, or an entire series of patient 22 characteristics.

Some pharmaceutical information can be viewed at 30.10 independently from the existence of any particular patient 22 or medical condition. Pharmaceutical information can viewed in terms of a group of pharmaceuticals 32 sharing a common characteristic or attribute, or as a specific individual pharmaceutical 32. A group of pharmaceuticals 32 can be selected at 30.16 by choosing a category or type of pharmaceutical 32. Means for choosing a category or type of drug include medical characteristics such as by disease or medical treatment protocol. Pharmaceutical 32 selection could also incorporate business or reimbursement rule 34 characteristics such as which pharmaceuticals 32 can be automatically subjected to the pre-certification 38 process or are otherwise approved under a particular health plan of a payor 60. To select a particular pharmaceutical 32, the java script at 30.12 is executed allowing a particular pharmaceutical to be selected at 30.14. Whether a single pharmaceutical 32 is selected or an entire category of pharmaceuticals 32 are selected, detailed information for a particular pharmaceutical 32 can be viewed at 30.20 by execution of the java script at 30.18. In either case, drug results particular use of the drug 32 can be selected at 30.14.

The drug information page 30.10 and related pages can be used to: identify undesirable drug interactions; identify potential allergy interactions; confirm the reimbursement rules 34 relating to the pharmaceutical 32, identify pharmaceuticals 32 in the formulary 24.

The capabilities of the prescription subsystem are enhanced by the ability of the prescription subsystem to communicate with the reimbursement subsystem and the pharmaceutical subsystem. The prescription subsystem allows health care providers 30 to interact with payors 60, PBMs 50, and pharmacists 40 in an efficient and proactive manner saving providers 30 both time and money 44. By allowing providers 30 to generate pre-certified 38 prescriptions 28, the total number of transactions, activities, re-works, and follow-ups is reduced for all of the parties involved. Allowing both providers 30 and pharmacies 40 to manage their interactions using the system 20 may substantially reduce the time pharmacists 40 and providers 30 spend trying to call each other on the phone to clarify or remedy prescription discrepancies. The provider 30 can monitor whether or not a patient 30 actually fills the prescription 28 because fulfillment of the prescription results in the appropriate data being entered by the pharmacist 30. Medication history is available to the provider 30 even if the medication was prescribed by a different provider 30 because the prescription 28 by the other provider 30 would be on the system, as would the fulfillment of such a prescription 28 by a pharmacist 40. Use of the system 20 provides the provider 30 and other entities with a centralized location for patient 22 information maximizing the probability that pharmaceutical interactions and allergic reactions would be detected before a prescription 28 is issued for a particular pharmaceutical 32. Changes in a payor's 60 treatment protocols, reimbursement rules 34, formulary 24, or other superceding events can be reacted to by a provider 30 in a substantially simultaneous manner by modifying or even canceling a prescription 32. Patient 22 refill behavior can be monitored and controlled to a greater degree by the provider 30. The heightened access to patient 22 information and medical information generally reduces the likelihood of malpractice liability. The automatic pre-certification 38 of all prescriptions 28 reduces the likelihood of fraudulent or abusive patient behavior. The integrated nature of the system 20 also provides for time savings on the part of providers 30.

FIG. 4b is a detailed input/output web page processing diagram. The patient record 30.07 which includes patient 22 information relevant to pharmaceutical selection 32 is inputted to the prescription page at 30.22. The output of the prescription page at 30.22 is ultimately sent to the provider home page at 30.02, unless the user simply wants to logout at 30.24 without utilizing the inputted information and pharmaceutical selections. The UserID variable is a unique key referring to the provider 30 using the system 20 and PatientID is a unique key for identifying the patient 22.

The prescription page at 30.22 displays information relating to the patient 22, including eligibility information, as well as a list of pharmaceuticals 32 from which the provider 30 can prescribe. Using the patient record at 30.07, the prescription page at 30.22 can generate an electronic prescription or an electronic representation of a paper prescription. The pharmaceutical(s) 32 to be included in the prescription 28 can either be typed in by the provider 30 or selected by highlighting the desired pharmaceutical(s) 32 from a list of pharmaceuticals 32 at 30.26. If pharmaceuticals 32 are selected by highlighting the desired pharmaceuticals 32 from a list at 30.26, those highlighted pharmaceuticals 32 are inserted into the selected pharmaceutical box at 30.28. The system then determines at 30.30 whether any of the selected drugs require pre-authorization at 30.32. Pre-authorization can be required if the pharmaceutical 32 is not listed in the formulary 24 and the patient is a member of the health plan with that formulary 24 or if the reimbursement rules 34 for a payor 60 requires pre-authorization for that particular pharmaceutical 32. If a pre-authorization is required at 30.30, that processing is done on the pre-authorization page at 30.32, described in greater detail below and in FIG. 4c.

The provider 30 is then asked at 30.34 if any pharmaceuticals 32 should be deselected as a result of undesirable pharmaceutical interactions, undesirable allergy interactions, or any other treatment based or reimbursement based reason. If no pharmaceuticals 32 need to be deselected, all of the selected pharmaceuticals are outputted to the prescription detail page at 30.36 described in greater detail below and in FIG. 4d. Included in the output is a DrugID which is a unique key for the particular pharmaceutical 32 being prescribed 28. If one or more pharmaceuticals 32 needs to be deselected by the provider 30, the provider can highlight the pharmaceuticals 32 to deselect at 30.38, resulting in their de-selection at 30.40. The provider 30 is free to either cancel processing at 30.42, or continue processing at 30.44 by sending the updated list of chosen pharmaceuticals 32 to the prescription detail page at 30.36, as described in greater detail below and in FIG. 4d.

FIG. 4c is an input/output diagram for the pre-authorization page at 30.32. The pre-authorization page displays information relating to the particular patient 22 as well as information relating to the prescribing provider 30. The page provides a means for inputting treatment and diagnosis information, as well as the medical justification for prescribing the pharmaceutical 32 that is to be preauthorized. Upon the issuance of a pharmaceutical 32, the data on the pre-authorization page will be outputted to the provider home page at 30.02 before the provider 30 logs out of the system 20 at 30.24. A pre-authorization form can be completed at 30.46.

If at 30.48 the provider 30 wishes to add one or more additional pharmaceuticals 32 to the prescription 28, those additions can be made on the prescription page at 30.23, with all previous selections already appearing in a highlighted format in the list of pharmaceuticals 32. If additional pharmaceuticals 32 are desired at 30.48, the UserID identifying the provider 30 and the MemberID identifying the member are sent to the prescription page at 30.23 so that the provider 30 can select additional pharmaceuticals at 30.23. If no additional drugs are desired at 30.48, the provider 30 can decide at 30.50 whether the pharmaceuticals 32 already highlighted for selection on the prescription 28 should be used to generate a prescription 32 at 30.36, or whether the provider does not desire to “save” the inputted information and instead wants to exit to the page at 30.25 without carrying forward any pharmaceutical 32 selections.

In a preferred embodiment of the invention, an e-mail (or similar communication such as a facsimile) containing the relevant pre-authorization information is sent directly to a payor or PBM when the provider confirms that the prescription 28 is to include the pre-authorized pharmaceutical 32. MemberID is a unique key representing the particular member, which is not necessarily the same as the patient 30 since an individual can receive health care coverage as the result of the affiliation with another person, such as coverage provided to a dependent.

FIG. 4d is an input/output diagram for the prescription detail page at 30.36. Inputs include the outputs from the prescription page at 30.22, as well as the outputs from the pre-authorization page at 30.32 if one or more pharmaceuticals 32 required pre-authorization. If a prescription 32 is ultimately issued by the provider 30, that information will be outputted to the provider home page at 30.02 before the provider logs off at 30.24.

The prescription detail page at 30.36 allows the provider to enter a diagnosis at 30.52 of the patient's 22 medical condition. The prescription subsystem supports multiple diagnoses for the same patient 22 and prescription 28. The strength of a particular pharmaceutical 32 is part of the pharmaceutical 32. The quantity of the pharmaceutical 32 is a separate characteristic which can then be entered at 30.54. SIG, which is pharmaceutical term of art relating to the directions for a particular pharmaceutical 32. SIG can be selected at 30.56. The number of days that a patient 22 is to take the prescribed pharmaceutical is set at 30.58, and the number of permitted refills is set at 30.60. The provider 30 may add whatever additional comments or notes are desired at 30.62. The prescription subsystem then computes estimated costs at 30.64 based on the unit price information contained in the system 20. If the provider 30 wants to cancel to prescription 28, the provider can choose to do so at 30.66, and return to the patient record page at 30.07. If the prescription 28 is issued at 30.68, the output is sent to the confirm prescription page at 30.70.

B. Reimbursement Subsystem

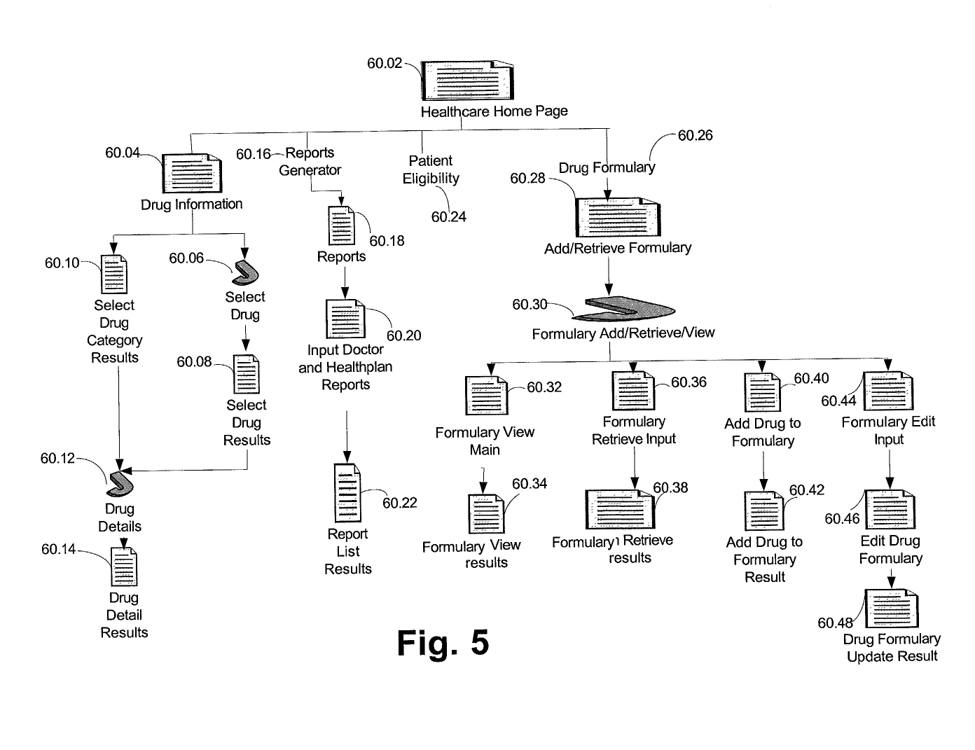

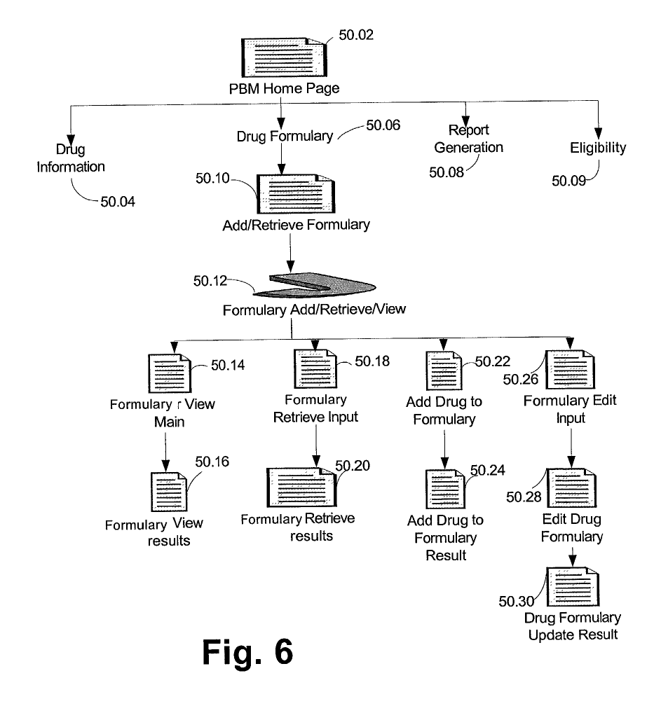

The reimbursement subsystem is the primary subsystem used by payors 60 and PBMs 50. The reimbursement subsystem incorporates into the system 20 information relating to the reimbursement rules 34, which include all of the rules, guidelines, and policies of a particular payor 60 or PBM 50. Reimbursement rules 34 can incorporate the results of ongoing utilization review and cost benefit analyzes 42, and can promote successful cost management 44. The relationship between a payor 60 and its PBMs 50 can vary substantially, but all types of payor 60/PBM 50 relationships can be supported by the system 20. Whether the functions of a PBM are performed by the payor 60 on end of the continuum, or whether a payor 60 delegates substantially all reimbursement rule 34 authority to various PBMs 50 on the other end of the continuum, the system 20 allows the relevant set of reimbursement rules 34 to be applied to a patient 22 throughout the life cycle of that patient's prescription 32. The flexibility of the system 20 to divide the reimbursement rule 34 responsibilities means that there is potentially significant overlap between what a PBM 50 does in one embodiment of the invention and what a payor 60 may do in a different embodiment of the invention. FIGS. 5 and 6 illustrate the potential for overlap. In any case, the system 20 is designed to make the reimbursement rules 34 easily accessible to other subsystems and entities so that processes need to be performed only once. For example, instead of correcting mistakes to a prescription 28 with regards to insurance coverage, the system 20 seeks to facilitate options for providers 30 and pharmacies 40 that comply with the reimbursement rules 34 of a payor 60 before a prescription 32 is generated by a provider 30 or filled by a pharmacist 40.

1. Payor

FIG. 5 is a site map for a payor 60 home page at 60.02. From the payor 60 home page at 60.02, there are four primary activities that can be initiated. The first option is a pharmaceutical 32 information page at 60.04 that provides the same functionality and links as is provided by the drug information page at 30.10 for a health care provider 30. A specific drug 32 can be selected at 60.08 by executing the java script at 60.06 for searching/selecting pharmaceuticals 32. An entire category of pharmaceuticals 32 can be selected at 60.10 on the basis of one shared characteristic shared by all the pharmaceuticals 32 in the list. Detailed information for any particular pharmaceutical 32 can be viewed at 60.14 by executing the java script at 60.12 for selecting detailed pharmaceutical 32 information. The drug information page at 60.04 is used to view pharmaceutical information, and that information is not limited to pharmaceuticals 32 in the formulary 24.

The second option on the payor 60 homepage 60.02 is a reports generator 60.16. The report generator 60.16 utilizes the reports and analysis 42 that the system 20 can generate relating to patients 22, pharmaceuticals 32, claims 26, reimbursements 26, utilization review, cost management 44, reimbursement rules 34, prescriptions 28, pharmacies 40, PBMs 50, or any other information potentially relating to a pharmaceutical 32 prescription 28. The page at 60.20, anticipates that reports will be generated relating to providers 30 and a particular health plan provided by a payor 60 and managed by a PBM 50. Results of such reports are listed at 60.22.

There are three general categories of reports 42 generated by the reimbursement subsystem. Compliance reports relate to comparing or contrasting of claims 36 that have been posted to the payor 60 or PBM 50 with claims 36 that have been paid 26 by the payor 60 or PBM 50. Utilization reports compare or contrast filled versus paid prescriptions 32 for a given date range by patient 22, provider 30, PBM 50, or health plan. The third category of reports are statistical reports that can be viewed by providers 30, PBMs 50, or payors 60. Providers 30 should only be able to view information relating to their own patients, and PBMs 50 and payors 60 are limited to information relating to their members. Some statistical reports relate to information over a certain date range, for example: the number of prescriptions 28 written; total dollar value of prescriptions 28 written; average cost of each prescription 28; percentage of total prescriptions 28 that are designated as a controlled substance; percentage of generic drug 32 utilization based on total prescriptions 28 written, percent of total prescriptions 28 designated “dispense as written”, or the percentage of formulary 24 compliance. The system 20 can also generate reports relating to the propensity of a provider 30 to prescribe pharmaceuticals 32 that are not in compliance with the automatic pre-certification 38 rules of the payor 60 or PBM 50.

Statistical reports 42 can also include the average number of prescriptions per member per health plan, the average number of prescriptions per membership by provider, the average number of prescriptions per patient by health plan, or the average number of prescriptions per patient by provider. Other types of reports 42 can be generated by the system 20, including patient history reports, pharmaceutical 32 interaction by category reports, and prescribed pharmaceutical by diagnoses reports.

The third option on the payor 60 homepage 60.02 is patient eligibility at 60.24. Eligibility information at 60.24 relates to a patient's 22 status as a member of a health plan provided by a payor 60, with pharmaceutical benefit management provided by a PBM 50. The health plan for which a patient 22 is eligible for coverage determines the reimbursement rules 34 for that patient 22. Different health plans have different reimbursement rules 34 even though they may be provided by the same payor 60 or managed by the same PBM 50.

The fourth option is for a drug formulary 24 at 60.26. A drug formulary 24 can be set by a payor 60 or by a PBM 50, but if there is a conflict, it is the formulary 24 set by the payor 60 that controls. A formulary 24 contains a list and description of every pharmaceutical 32 that a payor 60 provides reimbursement 26 for in accordance with the reimbursement rules 34. A formulary 24 includes indications, cautions, contra-indications, side-effects, dosage, cost, interactions, and other useful information. The formulary 24 set forth by the payor 60 or PBM 50 is viewable by providers 30 and pharmacists 40 providing services to patients 22 who are members of a health plan provided by a payor 60. Providers 30 and pharmacists 40 cannot make any changes to the formulary 24.

The add/retrieve formulary page at 60.28 triggers the execution of java script at 60.30 in the preferred embodiment of the invention. A list of pharmaceuticals 32 in the formulary 24 can be viewed at 60.32. Detailed information for a particular pharmaceutical 32 in the formulary 24 can be viewed at 60.34. Sophisticated and highly flexible searches can be conducted at 60.36 by inputting a key word into the system 20. The results of such a search can be viewed at 60.38. A pharmaceutical 32 can be added to the formulary 24 at 60.40. A pharmaceutical 32 can be linked to a particular category of pharmaceuticals at 60.42. A category of pharmaceutical results can vary from general categories such as pain relief to more specific categories to treat very specific medical conditions. A pharmaceutical 32 can belong to more than one category. Formulary input can be edited at 60.44. Information relating to the pharmaceutical 32 itself can be edited at 60.46 and information relating to the pharmaceutical or results category can be updated at 60.48.

The advantages of the reimbursement subsystem are significantly enhanced by the communications with the prescription subsystem and the pharmaceutical subsystem. The integrated nature of the overall system 20 allows a payor 60 or PBM 50 to proactively influence a provider's 30 prescription 28 behavior rather than attempt to fix problems after the fact. The system 20 allows a payor 60 to enforce its reimbursement rules 34 in a timely and proactive manner. The ability to a provider 30 to invoke the pre-certification 38 of prescriptions 28 and the resulting claims 36 is one aspect of that enforcement. The system 20 provides a mechanism for a payor 60 to communicate with a provider 30 before the provider 30 initiates any activity that would ultimately need to be undone in order to avoid a violation of a payor's 60 reimbursement rules 34, policies, or other guidelines. The elimination of manual interventions generates a significant cost savings to each entity involved in the process, including a payor 60 or PBM 50. Misuse of pharmaceuticals 32 by redundant prescriptions, overuse, filling a prescription 32 at a lower strength but higher volume and higher price, and other forms of misuse can be reduced through use of the system 20. Fraud and error can also be reduced, resulting in cost, safety, timeliness improvements. Better utilization review information and analysis 42 can be obtained through the integrative nature of the system 20. Error free prescription pre-certification 38 can be compared to the claims 36 submitted by a pharmacist 40 to reduce erroneous billing. The system 20 also supports cost savings 44 by the ability to influence the prescribing patterns of providers 30. Incremental preferred manufacturer rebates and a shift to generic pharmaceuticals can be facilitated by the system 20. The system 20 also supports decreased costs 44 through the use of automated prior-authorizations. The system 20 could also be used to increase payor 60 revenue through data mining efforts on behalf of pharmaceutical manufacturers and distributors.

2. Pharmaceutical Benefit Manager (“PBM”)

The optional role of a PBM 50 is illustrated in FIG. 6 which displays a subset of the functionality disclosed in FIG. 5. In alternative embodiments, a payor 60 can perform all of the functions of a PBM 50. In a preferred embodiment of the invention, a payor 60 uses a PBM 50 to manage reimbursement rules 34 for one or more health plans offered by the payor 60. The PBM homepage at 50.02 provides access to drug information at 50.04, drug formulary 24 at 50.06, report generation at 50.08, and eligibility information at 50.09.

The drug information at 50.04 is substantially identical to the drug information disclosed 60.04 with the possible exception that a PBM 50 may be limited to only certain health plans of the payor 60, with a corresponding limitation on drugs 32 and drug uses available for viewing pursuant to 50.04 and the web pages accessible through 50.04. Pharmaceutical information can be selected on the basis of a particular pharmaceutical 32 or on the basis of pharmaceutical categories with related treatment types or results. Detailed information relating to a particular pharmaceutical 32 product can be viewed, including all formulary 24 information.

The drug formulary 24 at 50.06 is substantially identical to the drug formulary 24 at 60.26, with the possible exception that a PBM 50 may be limited to certain health plans of a payor 60, with a corresponding limitation on drugs 43 and drug uses. Formulary 24 information can be added, modified, or retrieved at 50.10 by executing the appropriate java script at 50.12 from the web page at 50.10. A list of pharmaceuticals 32 in the formulary 24 can be viewed at 50.14, and detailed pharmaceutical information can be viewed at 50.16. Specific information can be used in a search of the formulary 24 at 50.18, and the search results are then viewable at 50.20. Pharmaceuticals 32 can be added to the formulary 24 at 50.22, and the added pharmaceutical 32 can be linked to a pharmaceutical category or type at 50.24. Formulary 24 information can be edited through the web page at 50.26, allowing the formulary 24 to be changed at 50.28 and pharmaceutical's 32 affiliation with a particular type or treatment protocol to be modified at 50.30.

The report generation module at 50.08 is substantially identical to the report generator at 60.16, with the possible exception that a PBM 50 will only have access to a subset of the providers 30 and health plan reports 42 at 60.20 and 60.22.

The eligibility module at 50.09 is substantially identical to the eligibility process at 60.24, with the possible exception that a PBM 50 will only have access to a subset of the patients 22 or members that a payor 60 would have.

A PBM's 50 use of the system 20 is enhanced by the communications with other subsystems such as the prescription subsystem and the pharmaceutical subsystem as well as the communications with other entities such as a provider 30, a pharmacist 40, or a payor 60. The integrated nature of the overall system 20 allows a PBM 50 to better proactively influence a provider's 30 prescription 28 behavior. The system 20 also allows a PBM 50 to better enforce the rules 34 set forth by a payor 60 in a timely and proactive manner. The ability of a provider 30 to pre-certify 38 prescriptions 28 and the resulting claims 36 is one aspect of that enforcement. The system 20 provides a mechanism for a PBM 50 to communicate with a provider 30 before the provider 30 initiates any activity that would ultimately need to be undone in order to avoid a violation of a payor's 60 reimbursement rules 34, policies, or other guidelines. The elimination of manual interventions generates a significant cost savings to each entity involved in the process, including the PBM 50. Misuse of pharmaceuticals 32 by redundant prescriptions, overuse, filling a prescription 32 at a lower strength but higher volume and higher price, and other forms of misuse can be reduced through use of the system 20. The functionality and advantages related to a PBM's use of the system 20 are very similar to the advantages achieved by the payor's use of the system 20. Both payors 60 and PBMs interact with providers 30 and pharmacists 40 in the form of reimbursement rules 34 the reimbursement subsystem.

C. Pharmaceutical Subsystem

The pharmaceutical subsystem is the subsystem used by the pharmacist 40. The pharmaceutical subsystem can receive electronic prescriptions 28 or a faxed or scanned paper copy of a prescription 28 from the prescription subsystem and generate an electronic representation of filling the prescription 32 with the delivery of a physical pharmaceutical 32 to a patient 22. In a preferred embodiment of the invention, the representation of a filled prescription 28 is generated in a substantially simultaneous manner with the filling of the prescription 28 and the distribution of the prescribed pharmaceutical 32.

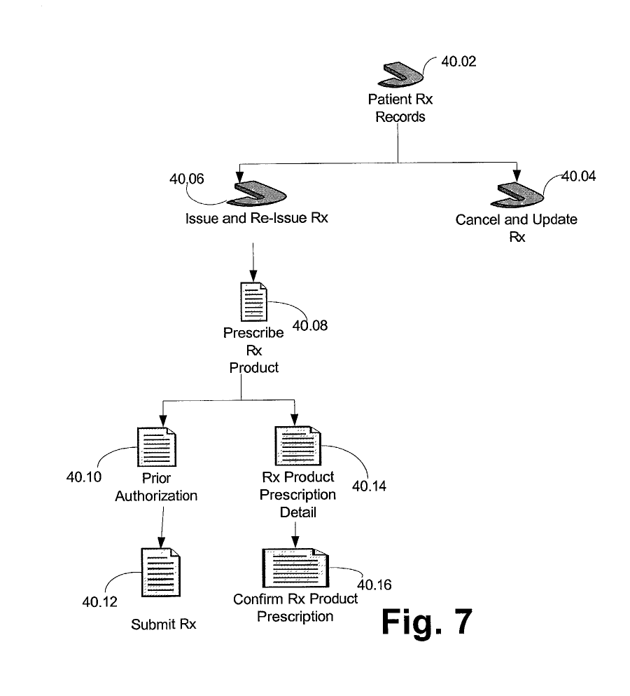

FIG. 7 illustrates some of the functionality that a pharmacist 40 can access through the pharmaceutical subsystem. Pharmaceutical prescriptions 28 need to be evaluated in the context of a particular patient 22 with a particular set of patient attributes, such as medication history, allergies, health plan eligibility, medical history, age, and any other attribute or characteristic that could impact the desirability of a particular pharmaceutical 32. The pharmacist 40 can view patient records at 40.02 in a manner consistent with the appropriate privacy regulations and policies. If the pharmacist 40 fills a pharmaceutical prescription, that information needs to be memorialized at 40.02 or its related web pages.

The process of filling or re-filling a pharmaceutical 32 prescription 28 triggers the activation of the java script at 40.06. If the prescription 28 was not sent electronically through the system 28, then the prescription 28 information needs to be inputted into the system at 40.08. The inputting of prescription information can be done in many different ways. A bar code label on the paper prescription 28 could be used to generate the appropriate information in the system 20. The pharmacist 40 could type the data into the system 20, or use a voice recognition technology to enter the information into the system 20. In a preferred embodiment of the invention, the prescription subsystem sends the prescription 28 in an electronic format to the pharmaceutical subsystem.

Before a prescription 28 is filled and before a claim 36 for filling a prescription 28 is sent to a PBM 50 or payor 60 at 40.12, the prescription 28 is re-evaluated in terms of the reimbursement rules 34 at 40.10. Confirmation of compliance with the reimbursement rules 34 provides an extra safeguard to enforce the policies of a payor 60 or PBM 50. The medical aspects of a prescription 28 can also be reviewed at 40.14, so that the appropriateness of the selected pharmaceutical 32 can be confirmed at 40.16 as it relates to pharmaceutical interactions, allergies, or other patient 22 attributes that could affect the desirability of filling a particular prescription. If for any appropriate business or medical reason the filling of a prescription 28 should not occur, the pharmacist 40 can cancel or potentially even modify the prescription 28 as appropriate at 40.04.

The pharmaceutical subsystem is an important bridge between the prescription subsystem and the reimbursement subsystem. The integrated nature of the system 20 enhances the benefits a pharmacist 40 receives in using the pharmaceutical subsystem. The system 20 facilitates a reduced liability risk from pharmaceutical interactions or allergy interactions. The system 20 also reduces time spent calling providers 30, payors 60, or PBMs 50 discuss authorization/certification issues. The reduction or elimination of such tasks facilitates more time for customer service and patient 22 care. The delivery of electronic or printed versions of pre-formatted and pre-certified 38 prescriptions 28 eliminates mistakes and time spent trying to read or understand a provider's handwritten prescription 28.

D. Patient Information

With the enactment of the Health Insurance Portability and Accountability Act of 1996 (“HIPAA”), preserving the privacy of patient 22 information that constitutes personally identifiable information is more important than ever. The patient 22 is a key element in any pharmaceutical information system. The system 20 requires that various entities access personal patient 22 information on an as needed basis. For example, if an allergy would result in an allergy interaction with a pharmaceutical, the pharmacist 40 as well as the provider 30 could be able to view that information.

The system 20 also provides a means for tracking information relating to a patient's 22 relationship with a payor 60. In the preferred embodiment of the invention, such information can be viewed by pharmacists 40, providers 30, and PBMs 50, but cannot be modified by those entities. In alternative embodiments, a patient 22 could view his or her own membership information as it relates to a payor 60. In most embodiments, only the payor 60 should be able to add members to a health plan on the system 20, or modify membership information on the system 20.

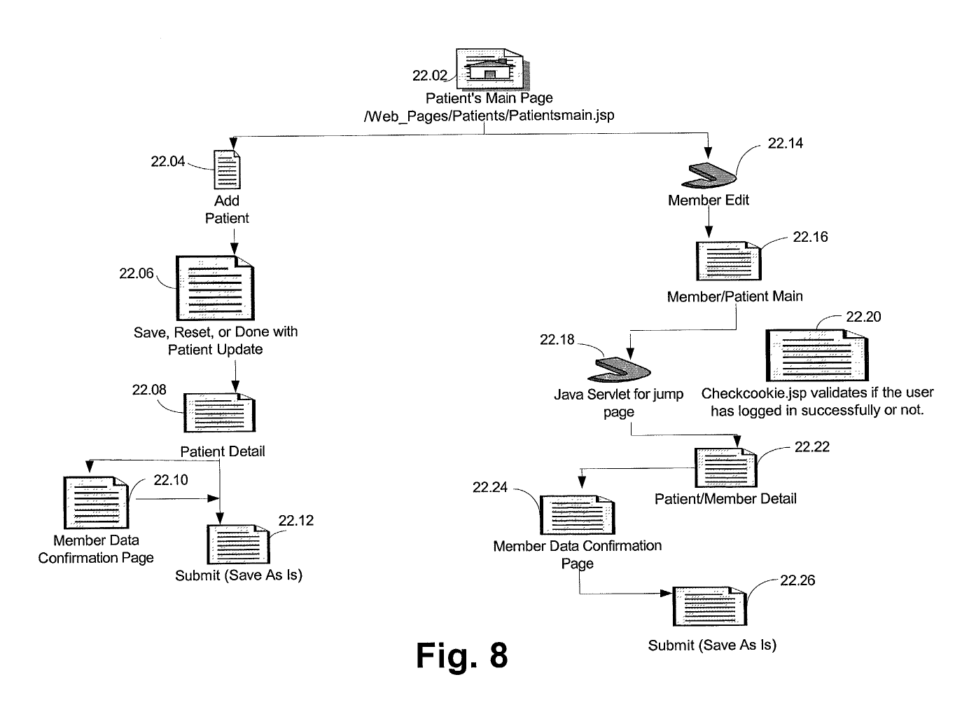

FIG. 8 discloses a subsystem for tracking membership (e.g. patient 22) information for a particular payor 60. New members or patients 22 can be added at 22.04. Once high level information relating to a patient 22 is inputted and saved at 22.06, more detailed information can be inputted at 22.08. Before detailed information is submitted or saved at 22.12, all inputs can be first confirmed on the member data confirmation page at 22.10.

Member information can then be edited at 22.14. The page at 22.16 is used to select a particular patient 22 in which to modify membership information. A security mechanism at 22.20 validates whether the user of the web page is authorized to modify membership information. The java servlet at 22.18 then calls out the detailed membership information for a particular patient 22 selected at 22.16. Detailed information can be viewed and changed at 22.22. All changes can be confirmed at 22.24 before the additions or modifications are saved and submitted at 22.26.

III. Communication Between Subsystems and Entities

As discussed above, the system 20 provides a mechanism for enhanced, comprehensive, integrated, and proactive communication between a payor 60, a PBM 50, a pharmacy 40, and a provider 30. The communication between the various different entities is facilitated by the communication between the subsystems incorporated into the system 20, including a prescription subsystem, a reimbursement subsystem, a pharmaceutical subsystem, and other subsystems relating to pharmaceutical information. The various subsystems can communicate with each other and share information with each other in a substantially simultaneous manner. The functional advantages of the system 20 can be illustrated by contrasting it with the prior art. The various subsystems can share and exchange information with each other in a substantially simultaneous manner, limited only by the computer and communication hardware incorporated in the system 20.

A. Prior Art Communication is Linear and Reactive

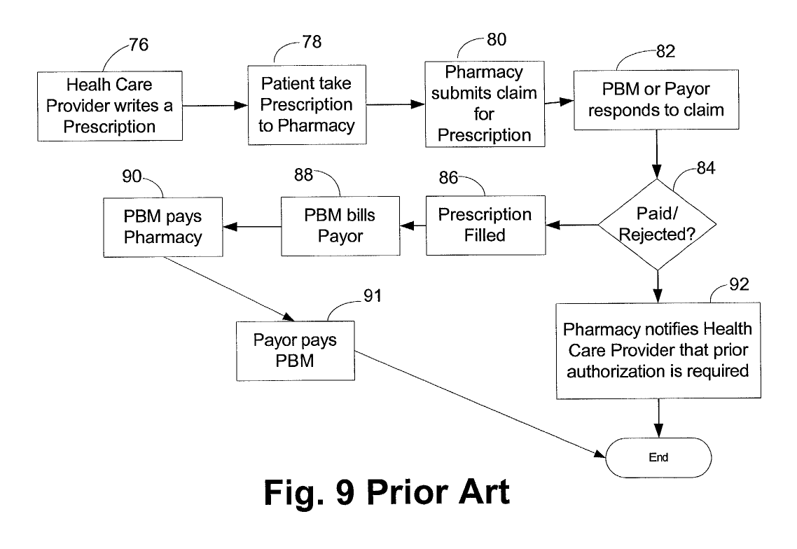

FIG. 9 is a flow chart of how providers 30, pharmacists 40, PBMs 50, and payors 60 interact with each other using prior art systems and methodologies.

At 76 the patient 22 visits a provider 30 who then writes a prescription 28. The prescription 28 is generally handwritten, and is often difficult for anyone but the provider 30 to read. The prescription is generated by the provider 30 without access to the payor's 60 reimbursement rules 34 or a formulary 24 managed by the payor 60. No automated access is provided to patient 22 information such as medication history or allergies, and such information is not kept in a centralized location.

At 78 the patient 22 takes the handwritten prescription 28 to a pharmacy 40. Many mistakes may occur from the simple inability of a pharmacist 40 to clearly read and understand the handwriting of the provider 30. The pharmacist 40 has no mechanism to obtain information regarding other medications 32 the patient 22 is using, or any medical conditions such as allergies that the patient 22 is suffering from.

At 80 the pharmacy 40 submits a claim 36 for the prescription 32 to the PBM 50 or payor 60. This submission can be sent via telephone, and often results in delays for the patient 22 and the pharmacist 40. In other instances, the submission of a claim 36 may not occur until after the prescription 28 is filled, when it is too late for any of the parties to alter their behavior or the substance of the prescription 28.

At 82 the PBM 50 or payor 60 responds to the claim 38. Given the lack of a pre-certification process 38, many claims 36 are rejected. If the claim 38 is rejected at 84, the pharmacist 40 at 92 notifies the provider 30 that prior authorization by the payor 60 or PBM 50 is required. This may result in the provider 30 generating a different prescription 28 that could similarly be rejected by the payor 60 or PBM 50. The rejection may also result in a frustrated patient 22 not receiving a pharmaceutical 32 and ultimately requiring more expensive treatment for a medical condition that became worse over time. In some cases, the pharmacy 40 may fill the prescription 28 without reimbursement 27, leading to undesirable cost shifting in unforeseen ways. No matter what the outcome, the process from 76 through 84 likely includes wasted time, effort, and money on the part of the patient 22, the provider 30, the pharmacist 40, the PBM 50, and the payor 60 when a claim 38 is rejected at 82.

If the claim 36 is paid at 84, then the prescription 28 can be filled at 86. Nothing prevents the pharmacy from filling a prescription 28 utilizing a lower strength pharmaceutical 32 at a higher volume and expense. The PBM 50 can then bill the payor 60 for payment at 88. The PBM 50 typically pays the pharmacy 40 at 90 without waiting for payment 27 by the payor 60 at 91.

B. The Invention Facilitates Direct and Proactive Communication

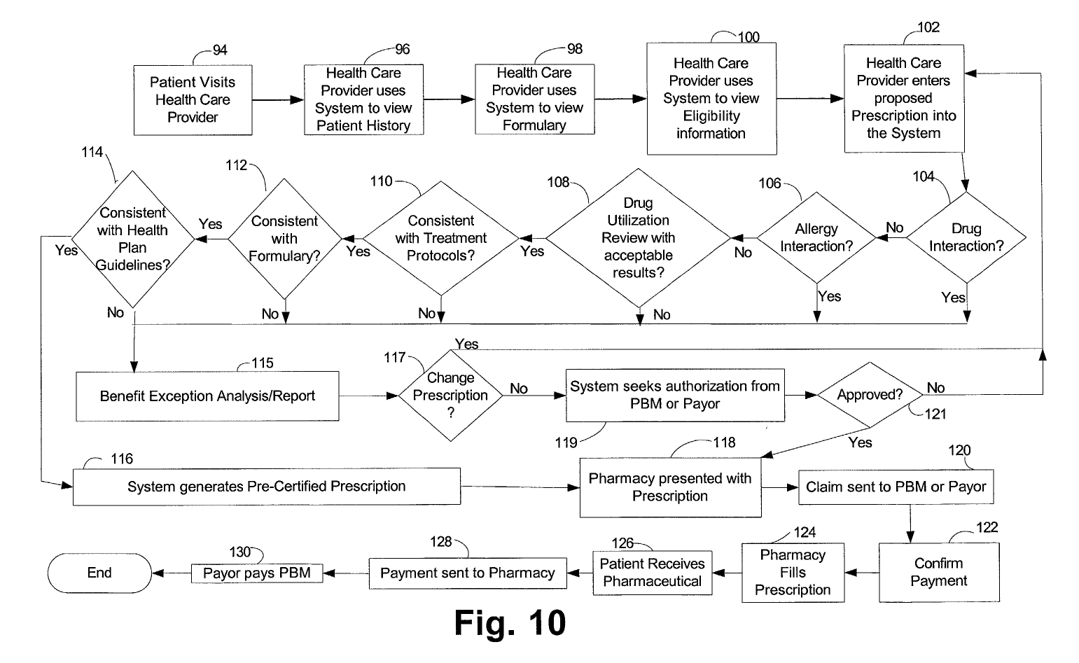

FIG. 10 is an illustrative flow chart of inter-entity and inter-subsystem communication using the system 20. The process begins at 94 with a patient 22 visit to a health care provider 30. The provider 30 can access patient 22 specific information on the system 20.

Patient 22 medical history can be viewed at 96. Because the system 20 integrates all aspects of the patient's 22 pharmaceutical information in an efficient manner, the medical history viewable at 96 is comprehensive without being redundant. Patient history at 96 includes allergy information, medication history which includes dosage and refill information, and any other patient 22 attribute or characteristic that could affect the desirability of a particular prescription 28 for a particular patient 22. In a preferred embodiment of the invention, the system 20 is integrated with other health care systems so that the patient 22 information available on the system 20 is as comprehensive as possible. The system 20 makes medical history information available in a timely and easy to access manner. In some embodiments of the invention, hand held wireless devices such as PDAs 64, pagers, or cell phones could be used by a provider 30 to view medical history, generate prescriptions 28, or otherwise interface with the system 20.

The provider 30 can then view formulary 24 information at 98. The formulary 24 is created by the payor 60 or the PBM 50 in a preferred embodiment of the invention so that the pharmaceuticals 32 listed in the formulary 24 are pre-selected to comply with the relevant reimbursement rules 34.

The provider 30 can then view eligibility and authorization information at 100. As discussed above, eligibility information relates to whether a patient 22 is covered by a health plan of the payor 60. Authorization refers to the reimbursement rules 34 of the payor 60, and the types of pharmaceuticals 32 and situations in which a payor 60 will cover certain treatment decisions.

The provider 30 can then enter a proposed prescription 28 into the system 20 at 102. In the preferred embodiment of the invention, a proposed prescription 28 has to pass each of the validations from 104 through 114 in order for an automatically pre-certified status 38 to be attributed to a prescription 28; a prescription 28 which will automatically result in a reimbursement 26 from the payor 60 or PBM 50.

If there is an unfavorable drug interaction between the proposed prescription 28 and some other prescribed pharmaceutical 32 being used by the patient 22, the proposed prescription 28 is rejected even if the other prescription 28 was issued by a different provider 30. Initial rejections can be based on purely medical issues such as drug interactions 104 and allergy interactions 106. Initial rejections can also be based on a combination of medical and business issues, such as acceptable drug utilization results at 108, consistency with treatment protocols at 110, consistency with the formulary at 112 and consistency with the health plan guidelines and other reimbursement rules 34 at 114.

In the case of an initial rejection due a purely medical issue at 104 or 106, the provider can override the rejection to generate the prescription 32. In alternative embodiments, the provider's 30 professional judgment can be definitely limited by the system 20. In the case of an initial rejection at 108, 110, 112, or 114, the system 20 provides a benefit exception analysis/report at 115 specifically informing the provider 30 of why a certain pharmaceutical 32 is not approved by the automatic pre-certification process 36. The provider 30 at 117 then has the opportunity to change the pharmaceutical 32 selection at 117 so that automatic precertification status 38 can be achieved. If the provider 30 decides to change the prescription 32, the process returns to the entering of a proposed prescription 32 at 102. If the provider 30 decides to pursue the initial prescription 32, the system 20 will automatically seek authorization 119 from the appropriate PBM 50 or payor 60. If approval is not received at 121, the provider 30 must either make a new selection at 102, or forego reimbursement 27 by the payor 60 or PBM 50. If approval is given at 121, the pharmacy 40 is presented with the prescription 32 at 118, and the process continues as if the prescription 32 was automatically approved as pre-certified 38. Data relating to a provider's 30 request to seek approval for pharmaceuticals 32 outside the automatic pre-certification process 38 is recorded by the system 20 for potential subsequent analysis by the payor 60, PBM 50, or provider 40.

After checking for unfavorable drug interactions at 104, the system 20 then verifies that there is no unfavorable allergy interaction at 106. An unfavorable allergy interaction is an interaction between a pharmaceutical 32 and an attribute of a patient 22 such as an allergy. If an unfavorable allergy interaction is detected at 106, the proposed prescription 28 is rejected. The rejection process is described above.

If no unfavorable allergy or medical attribute interaction is detected at 106, drug utilization information 42 is then used to evaluate the desirability of the proposed prescription 28 at 108. Drug utilization information 42 can be incorporated into the reimbursement rules 34 for a payor 60. If the utilization of the proposed prescription 32 is insufficient according the reimbursement rules 34 for the particular purpose of the treatment, the proposed prescription 28 is rejected as described above.

If the drug utilization review at 108 reveals an acceptable cost benefit analysis, the system 20 then determines at 110 whether or not the proposed prescription 28 is consistent with the treatment protocols as set forth by the payor 60 or PBM 50. Treatment protocols are incorporated into the reimbursement rules 34 of a payor. If the proposed prescription 32 is not compatible with the appropriate treatment protocol, the proposed prescription 28 is rejected as described above.

If the proposed prescription 28 complies with the appropriate treatment protocol at 110, then at 112 the proposed prescription 28 is then compared to the formulary 24 to confirm consistency with the formulary 24. In a preferred embodiment, only those pharmaceuticals 32 consistent with the formulary 24 incorporated into the reimbursement rules 34 of the payor 60 can be selected by a provider 30 for use at 102. If the proposed prescription 28 is not compatible with the appropriate formulary 24 information, the proposed prescription 28 is rejected as described above.

If the proposed prescription 28 is consistent with the formulary 24 at 112, the proposed prescription is otherwise evaluated at 114 in terms of the reimbursement rules 34 set forth by the payor 60. If the proposed prescription 28 is not consistent with the reimbursement rules 34, the proposed prescription is rejected as described above. Otherwise, the system 20 generates a prescription 28 at 116. In a preferred embodiment, the prescription 28 is pre-certified 38.

The prescription 28 is then presented to the pharmacist 40 at 118. In a preferred embodiment of the invention, the system 20 sends an prescription 28 in an electronic format to the pharmacist 40. In an alternative embodiment, the patient 22 or some other person on behalf of the patient 22, presents a pre-formatted prescription 28 generated from a laser printer. Other alternative embodiments may utilize devices such a telephones, fax machines, and scanners, to automate the process beyond a the printing of a preformatted prescription 28. A pre-formatted printed prescription 28 is clearly printed, and is also identifiable from its bar coding. In an alternative embodiment, an electronic representation of a prescription 28 can be sent.

After the prescription 28 is presented to the pharmacist 40 but before the pharmacist 40 distributes the pharmaceutical 32 to the patient, the pharmacist 40 can send a claim 36 to the payor 60 or PBM 50 at 120. In the preferred embodiment of the invention, the claim 36 is “sent” electronically using the system 20, where the receiving entity (a payor 60 or PBM 50) responds by the automatic application of the reimbursement rules 34. In alternative embodiments, personnel for the payor 60 or PBM 50 can respond by using the system 20. Due to the pre-certification 38 process at 108, 110, 112, and 114, most of the claims 38 at 120 should be approved. The system 20 confirms payment 27 for such claim 38 at 122.

The pharmacist 40 can then fill the prescription 28 at 124. In a preferred embodiment of the invention, an electronic representation of the filling of the prescription 28 is entered on the system 28 in a substantially simultaneous manner as the pharmacist 40 fills the prescription 28. In a preferred embodiment, payment 26 is sent to the pharmacy 40 in a substantially simultaneous manner at 128 as the patient receives the pharmaceutical at 126.

C. Post-Prescription Communications

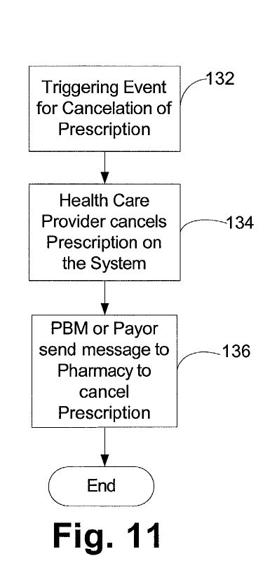

The system 20 facilitates communication between a payor 60, a PBM 50, a pharmacist 40, and a provider 30 even after a prescription 32 is generated and filled. FIG. 11 is a flow chart illustrating the cancellation or modification of a prescription 28. The modification of a prescription at 132 is an event triggered process. There must be an event that triggers the modification or cancellation of a prescription 28. The triggering event could be a change in the condition of a patient 22, a change in the reimbursement rules 34 of a payor 60 or PBM 50, or evidence of fraud, misuse, or redundancy on the part of a provider 30, pharmacist 40, or patient 22.

As result of the event at 132, a provider 30 can then modify or cancel the prescription 28 at 134. The ability to modify or cancel prescriptions is provided to a provider 30 at 30.06 as described above. The system 20 then communicates the modification or cancellation to the pharmacy 40 on behalf of the payor 60 or PBM 50 at 136. If the prescription 28 has already been filled, a cancellation or modification will only be effective when the patient 22 attempts to refill the prescription 28.

In accordance with the provisions of the patent statutes, the principles and modes of operation of this invention have been explained and illustrated in preferred embodiments. However, it must be understood that this invention may be practiced otherwise than as specifically explained and illustrated without departing from its spirit or scope.

What is claimed is:

1. A pharmaceutical information tracking system comprising:
a payor;
a computer system accessible by said payor including:
a pharmaceutical subsystem, comprising a pharmaceutical representation;
a prescription subsystem, comprising a prescription representation for said pharmaceutical representation; and
a reimbursement subsystem, comprising a reimbursement representation for said prescription representation.

2. A pharmaceutical information tracking system as recited in claim 1:
wherein said pharmaceutical subsystem is accessible by said prescription subsystem and said reimbursement subsystem;
wherein said prescription subsystem is accessible by said pharmaceutical subsystem and said reimbursement system; and
wherein said reimbursement subsystem is accessible by said pharmaceutical subsystem and said prescription subsystem.

3. A pharmaceutical information tracking system as recited in claim 1, said computer system further including a single database or a plurality of interconnected databases.

4. A pharmaceutical information tracking system as recited in claim 1, said reimbursement subsystem further comprising a reimbursement rule and said reimbursement representation including a monetary value, said reimbursement rule determining the monetary value of said reimbursement representation.

5. A pharmaceutical information tracking system as recited in claim 1, said computer system further including an eligibility subsystem and an eligibility criteria, said eligibility subsystem communicating said eligibility criteria to said reimbursement subsystem, said pharmaceutical subsystem, or said prescription subsystem.

6. A pharmaceutical information tracking system as recited in claim 5, said eligibility subsystem further comprising an eligibility decision, wherein said eligibility subsystem analyzes said eligibility criteria to generate said eligibility decision.

7. A pharmaceutical information tracking system as recited in claim 6, wherein said eligibility decision is sent to said prescription subsystem before said prescription subsystem generates said prescription representation.

8. A pharmaceutical information tracking system as recited in claim 6, said pharmaceutical subsystem further comprising a plurality of pharmaceutical representations and a subset of eligible pharmaceutical representations, wherein said prescription subsystem selectively identifies said subset of eligible pharmaceutical representations from said plurality of eligibility representations using said eligibility decision.

9. A pharmaceutical information tracking system as recited in claim 1, said prescription subsystem further comprising a patient attribute, wherein said prescription subsystem analyzes said patient attribute to selectively create said prescription representation.

10. A pharmaceutical information tracking system as recited in claim 9, wherein said patient attribute is a medical history.

11. A pharmaceutical information tracking system as recited in claim 10, wherein said medical history includes medication history.

12. A pharmaceutical information tracking system as recited in claim 1, said prescription subsystem further comprising a formulary, said prescription subsystem selectively identifying said pharmaceutical representation in said formulary and selectively creating said prescription representation.

13. A pharmaceutical information tracking system as recited in claim 1, said pharmaceutical subsystem further comprising a representation of an unfavorable pharmaceutical interaction in a patient caused by two or more pharmaceuticals wherein each pharmaceutical is represented by said pharmaceutical representation, and wherein said pharmaceutical subsystem detects said representation of an unfavorable pharmaceutical interaction.

14. A pharmaceutical information tracking system as recited in claim 13, said unfavorable pharmaceutical interaction including an a representation of redundant pharmaceuticals.

15. A pharmaceutical information tracking system as recited in claim 13, wherein said prescription subsystem is prevented from generating said prescription representation for said pharmaceutical representations that would result in said representation of unfavorable pharmaceutical interaction.

16. A pharmaceutical information tracking system as recited in claim 1, further comprising a representation of an allergy and a representation of an unfavorable allergy interaction in a patient between said allergy and a pharmaceutical represented by said pharmaceutical representation, wherein said pharmaceutical subsystem detects said representation of an unfavorable allergy interaction in a patient.

17. A pharmaceutical information tracking system as recited in claim 16, wherein said prescription subsystem is prevented from generating said prescription representation for said pharmaceutical representation that would result in said representation of an unfavorable allergy interaction in a patient.

18. A pharmaceutical information tracking system as recited in claim 1, including a superseding criteria, wherein said prescription subsystem alters said prescription representation after said prescription subsystem creates said prescription representation.

19. A pharmaceutical information tracking system as recited in claim 18, wherein said altering includes a canceling of said prescription representation.

20. A pharmaceutical information tracking system as recited in claim 1, wherein said prescription subsystem includes a representation of filling a prescription, wherein said prescription subsystem monitors said representation of filling a prescription.

21. A pharmaceutical information tracking system as recited in claim 20, wherein said representation of filling a prescription includes a representation of re-filling a prescription.

22. A pharmaceutical information tracking system as recited in claim 1, said reimbursement subsystem further comprising a pre-certified status, wherein said reimbursement of said pre-certified status is attributed to said prescription representation by said prescription subsystem at the time said prescription subsystem selectively creates said prescription representation.

23. A pharmaceutical information tracking system as recited in claim 22:
said computer system further including an eligibility subsystem, said eligibility subsystem further comprising an eligibility criteria and an eligibility decision;
wherein said eligibility subsystem analyzes said eligibility criteria to create said eligibility decision;
wherein said prescription subsystem analyzes said eligibility decision to determine if said pre-certified status is attributed to said prescription representation.

24. A pharmaceutical information tracking system as recited in claim 1, said reimbursement subsystem further comprising a reimbursement rule and a change in said reimbursement rule, wherein said change in said reimbursement rule is made by said reimbursement subsystem, and said change in said reimbursement rule is accessible by said prescription subsystem or said pharmaceutical subsystem in a substantially simultaneous manner.

25. A pharmaceutical information tracking system as recited in claim 1, said reimbursement subsystem further comprising a cost analysis and a cost criteria, wherein said reimbursement subsystem generates said cost analysis using said cost criteria.

26. A pharmaceutical information tracking system as recited in claim 1, said reimbursement subsystem further comprises a treatment protocol, wherein said reimbursement subsystem communicates said treatment protocol to said prescription subsystem.

27. A pharmaceutical information tracking system as recited in claim 1, said prescription subsystem further comprising a diagnosis, wherein said prescription subsystem stores said diagnosis with said prescription.

28. A pharmaceutical information tracking system comprising:
a payor;
a computer system accessible by said payor including:
a pharmaceutical subsystem comprising a plurality of pharmaceutical representations, a representation of an unfavorable pharmaceutical interaction, a representation of an unfavorable allergy interaction, and a subset of eligible pharmaceutical representations;
a prescription subsystem comprising a plurality of prescription representations, a patient attribute representation, and a representation of filling a prescription;
a reimbursement subsystem comprising a reimbursement representation, a reimbursement rule, a pre-certified status, a cost analysis, a cost criteria, and a treatment protocol; and
an eligibility subsystem comprising an eligibility criteria and an eligibility decision; and
wherein said pharmaceutical subsystem, said prescription subsystem, said reimbursement subsystem, and said eligibility subsystem share information in a substantially simultaneous manner.

29. A method of tracking pharmaceutical information comprising the steps of:
using a single computer system to track pharmaceutical, prescription, eligibility and reimbursement information; and
pre-certifying a prescription before generating an electronic representation of the prescription.

30. A method of tracking pharmaceutical information as recited in claim 29, further comprising detecting a representation of an unfavorable pharmaceutical interaction.

31. A method of tracking pharmaceutical information as recited in claim 29, further comprising identifying a representation of an unfavorable allergy interaction.

32. A method of tracking pharmaceutical information as recited in claim 29, further comprising altering a prescription representation after generating a representation of a filled prescription.

33. A method of tracking pharmaceutical information as recited in claim 29, further comprising monitoring a representation of patient usage after generating a representation of a filled prescription.

34. A method of tracking pharmaceutical information as recited in claim 29, further comprising consulting an electronic formulary before generating a prescription representation.
